(19) United States
(12) Patent Application Publication
(10) Pub. No.: US 2004/0166584 A1
(43) Pub. Date: Aug. 26, 2004

(54) Method and apparatus for monitoring of a chemical characteristic of a process chemical

(76) Inventors: Ashutosh Misra, Plano, TX (US); Matthew L. Fisher, Allen, TX (US)

Correspondence Address: Linda K. Russell, Air Liquide, Intellectual Property Dept., 2700 Post Oak Blvd., Suite 1800, Houston, TX, 77056-5797, US

(21) Appl. No.: 10/733,865

(22) Filed: Dec. 11, 2003

Related U.S. Application Data
(63) Continuation-in-part of application No. 10/029,083, filed on Dec. 20, 2001.
(60) Provisional application No. 60/257,700, filed on Dec. 21, 2000.

(51) Int. Cl. G01N 21/00

(52) U.S. Cl. 436/164; 422/82.05; 422/62; 436/55

(57) ABSTRACT

A method and apparatus for performing online monitoring of a chemical state of a process material. A request to provide a process chemical to a processing tool is received. The process chemical is transported through a chemical transport unit, based upon the request, to the processing tool. An online monitoring of a chemical state of the process chemical is performed. The online monitoring of the process chemical includes analyzing a resultant of a radiation signal sent through the process chemical to determine a refractive index to determine whether the chemical state of the process chemical is within a predetermined level of tolerance.

### CROSS REFERENCE TO RELATED APPLICATIONS

This application is a continuation-in-part of co-pending U.S. application Ser. No. 10/029,083, filed Dec. 20, 2001, which is related to the provisional application Serial No. 60/257,700, filed Dec. 21, 2000, the entire contents of which are incorporated herein by reference.

### BACKGROUND OF THE INVENTION

1. Field of the Invention

This invention relates to supplying chemicals for manufacturing processes and, in particular, to an apparatus and a method for performing online monitoring of a chemical characteristic of a chemical slurry.

2. Related Art

The technology explosion in the manufacturing industry has resulted in many new and innovative manufacturing processes. Today's manufacturing processes, particularly semiconductor manufacturing processes, call for a large number of important steps. These process steps are usually vital, and therefore, require a number of inputs that are generally fine-tuned to maintain proper manufacturing control.

The manufacture of semiconductor devices requires a number of discrete process steps to create a packaged semiconductor device from raw semiconductor material. The various processes, from the initial growth of the semiconductor material, the slicing of the semiconductor crystal into individual wafers, the fabrication stages (etching, doping, ion implanting, chemical-mechanical planarization, or the like), to the packaging and final testing of the completed device, are so different from one another and specialized that the processes may be performed in different manufacturing locations that contain different control schemes and involve delivery of various materials from one site to another.

Advancements in process technology has allowed for more efficient processing of semiconductor wafers to produce integrated circuits in a more efficient and accurate manner.

One important process is a chemical mechanical planarization (CMP) process that is used to process semiconductor wafers. There are various layers of films on a semiconductor wafer that may be polished and planarized using this process. The films that are processed may include silicon oxide, silicon nitride, aluminum fill, and/or tantalum nitride film. More recently, copper has been used to develop interconnects and other structures on semiconductor wafers. Generally, a copper film is polished in order to planarize the copper film placed upon a layer of the semiconductor wafer being processed. Processes such as oxide CMP and nitride CMP may be performed to polish copper layers.

The consistency of the chemicals that are used in performing various processes performed on semiconductor wafers, such as CMP processes, may become important in achieving consistent results. Many chemicals used for processes, such as CMP, are delivered in a slurry form. Often, copper slurry contains particles of aluminum oxide used as an abrasive agent in performing the CMP process. Additionally, the slurries may contain chemical mediums, such as benzotriazole, which may be used to protect the copper film from corrosion. Furthermore, other chemical agents, such as hydrogen peroxide, may be used as an oxidizing agent, atonalamean and other complexing agents. Disruption or changes in the chemical characteristic of the slurry may cause errors and misprocessing of various processes, such as CMP processes, performed on the semiconductor wafers.

Process designers have attempted to provide a solution in an attempt to maintain the consistency of slurry. One solution offered by process designers involves a particle probe system, as described in U.S. Pat. No. 6,275,290: “Chemical Mechanical Planarization (CMP) Slurry Quality Control Process and Particle Size Distribution Measuring Systems.” U.S. Pat. No. 6,275,290 describes a particle distribution probe which uses special processing including a modified Twomey/Chahine iterative convergence technique and a specially constructed sample cell to obtain particle size distribution measurements from optically dense slurries, such as the slurries used in the semiconductor industry for chemical mechanical planarization. Spectral transmission data is taken over the spectral range of 0.20-2.5 microns. In addition to the calculation of particle size distribution from the measured transmitted light, the invention described in U.S. Pat. No. 6,275,290 is claimed to assist in the detection of other fundamental causes of slurry degradation, such as foaming and jelling.

However, the technology provided by U.S. Pat. No. 6,275,290 has various drawbacks. The technique described in U.S. Pat. No. 6,275,290 is not a direct measure of suspended solids in a slurry; it only gives a qualitative measure of the change in suspended solids. Furthermore, if a slurry were undergoing a simultaneous change in the level of suspended solids and a change in particle size distribution, the method disclosed in U.S. Pat. No. 6,275,290 would be unable to distinguish the root cause of such change, since the light transmission at various wavelengths specified in this patent would be affected by such changes. Additionally U.S. Pat. No. 6,275,290 relies on changes of chemical properties over a period of time for detection of chemical properties, by monitoring the wavelengths over a period of time. This would cause delay in characterizing the chemical characteristics of a process chemical, resulting in improperly processed semiconductor wafers. Hence, this method would not be an efficient and accurate quantifier of a change in chemical characteristics alone. Also, the presence of other species in the slurry, such as oxidizers (like H₂O₂) and organic acids (like benzotriazole) will affect the light transmission at certain wavelengths in the method.

The current state of the art lacks an efficient method and system for monitoring the chemical state of a process chemical (e.g., slurries used in wafer-processing) in an in-line fashion. Generally, these slurries, or process chemicals, may experience a decomposing of various chemicals in the slurry. Further, merely performing a physical analysis may not adequately detect this change. Those skilled in the art have employed pH meters, for example, but they are not effective in detecting minute chemical changes. Generally, pH meters are not sensitive enough to detect the chemical state that would affect semiconductor wafers. Monitoring chemical changes over a period of time does not provide a solution to the problems described herein. A lack of on-line analysis of chemical characteristics may result in scratches on the semiconductor wafers, corrosion, and other problems. These problems may affect yields of semiconductor wafers where much of the processed semiconductor wafers may have to be rejected. The state of the art generally lacks an efficient and accurate assessment of the slurry for use in various wafer-processing steps.

The present invention is directed to overcoming, or at least reducing, the effects of one or more of the problems set forth above.

### SUMMARY OF THE INVENTION

In one aspect of the present invention, an apparatus for performing online monitoring of a chemical state of a process material is provided. The apparatus of the present invention includes a radiation source for providing a radiation signal into a process chemical. The apparatus also includes a refraction index sensor for detecting the refraction index resulting from the radiation signal. The apparatus also includes a controller to determine whether a chemical state of the process chemical is within a predetermined tolerance level in an online manner, in response to the refraction index.

In yet another aspect of the present invention, a system for performing online monitoring of a chemical state of a process material, is provided. The system of the present invention includes a process chemical unit for providing a slurry. The system also includes a processing tool for performing a process upon a semiconductor wafer using the slurry. A slurry transport conduit transports the slurry from the process chemical unit to the processing tool. The slurry transport conduit includes

In another aspect of the present invention, a method for performing online monitoring of a chemical state of a process material is provided. A request to provide a process chemical to a processing tool is received. The process chemical is transported through a chemical transport unit, based upon the request, to the processing tool. An online monitoring of a chemical state of the process chemical is performed. The online monitoring of the process chemical includes analyzing a resultant of a radiation signal sent through the process chemical to determine a refractive index to determine whether the chemical state of the process chemical is within a predetermined level of tolerance.

In yet another aspect of the present invention, a computer readable program storage device encoded with instructions is provided for performing online monitoring of a chemical state of a process material. The computer readable program storage device encoded with instructions that, when executed by a computer, performs a method, which includes: receiving a request to provide a process chemical to a processing tool; transporting the process chemical through a chemical transport unit to the processing tool based upon the request; and performing an online monitoring of a chemical state of the process chemical. The online monitoring includes analyzing a refractive index signal caused by the presence of a radiation signal sent through the process chemical to determine whether the chemical state of the process chemical is within a predetermined level of tolerance.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 illustrates a block diagram of a system for monitoring a physical chemical characteristic of a material used for a manufacturing process, in accordance with one embodiment of the present invention;

FIG. 2 illustrates a more detailed block diagram depiction of a chemical analysis unit of FIG. 1, in accordance with one embodiment of the present invention;

FIG. 3 illustrates a more detailed block diagram depiction of a first embodiment of a refractive index sensor of FIG. 2, in accordance with one embodiment of the present invention;

FIG. 4 illustrates a more detailed block diagram depiction of a first embodiment of a refractive index sensor of FIG. 2, in accordance with one embodiment of the present invention;

FIG. 5 illustrates one embodiment of a slip stream for performing a chemical analysis in accordance with one embodiment of the present invention;

FIG. 6 illustrates a graph that depicts the relationship of the refractive index and a percentage of hydrogen peroxide associated with a process chemical, in accordance with one embodiment of the present invention;

FIG. 7 illustrates a graph that depicts the relationship of the refractive index and a percentage of glycol ether associated with a process chemical, in accordance with one embodiment of the present invention;

FIG. 8 illustrates a more detailed block diagram depiction of the system of FIG. 1, in accordance with one illustrative embodiment of the present invention; and

FIG. 9 illustrates a flowchart that provides a method for monitoring a chemical state of a material used for a manufacturing process, in accordance with one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Embodiments of the present invention provide for a method and apparatus for performing on-line monitoring of a chemical characteristic in a process chemical, such as a slurry used to perform a chemical-mechanical planarization (CMP) process. Process chemicals may be delivered in the form of slurry from one location of a manufacturing area to another for use in processing of semiconductor wafers. Embodiments of the present invention provide for performing a refractive index analysis to determine a characteristic of the processed chemical in an in-line format. In one embodiment, the present invention provides for determining whether a change in the chemical characteristic has occurred from a known condition to a second condition in an in-line format. Utilizing embodiments of the present invention, an on-line, real time, or a near real time assessment of the chemistry of the process chemical may be determined, thereby providing the ability to react in an instantaneous or near instantaneous fashion. Embodiments of the present invention provide for a light transmission, which may be, for example, 800 to 10,000 nanometer wavelengths, to be utilized for analysis of the refractive index resulting from the transmission of the radiation.

Embodiments of the present invention provide for a substantially real time analysis of the slurry. Embodiments of the present invention provide for a method and apparatus for performing a feedback correction directed to modifying the nature of the slurry to have physical characteristics that are generally within predetermined tolerances for use in semiconductor wafer processing, such as CMP processes.

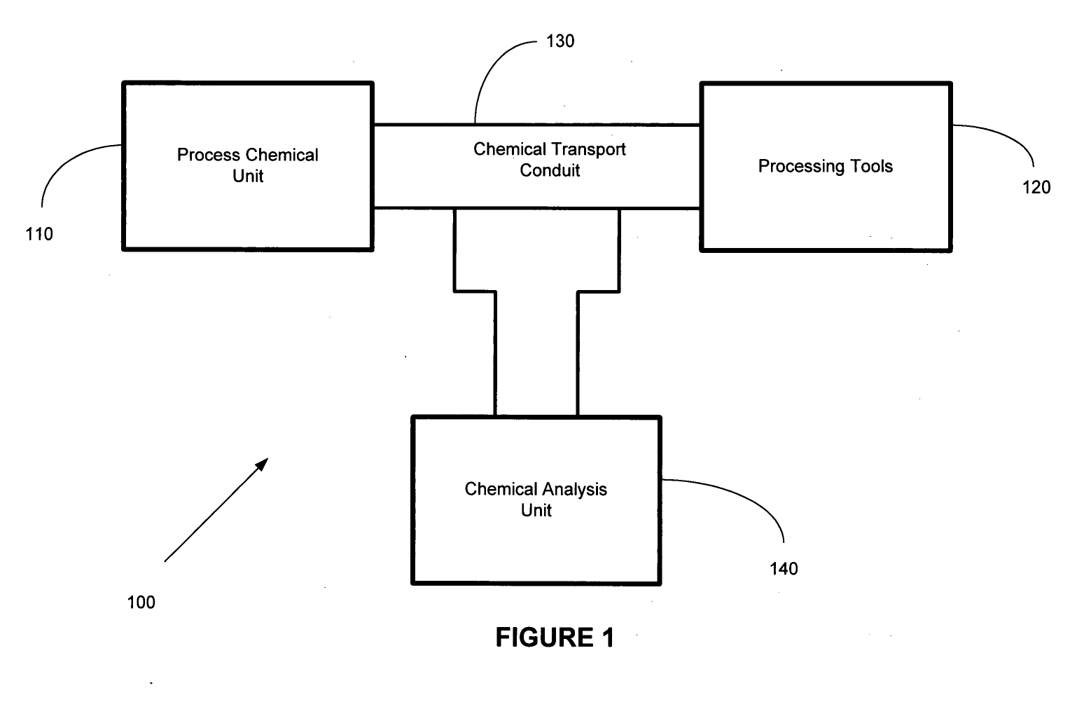

Turning now to FIG. 1, a system 100 that performs a slurry analysis in accordance with embodiments of the present invention is illustrated. In one embodiment, the system 100 comprises a process chemical unit 110, a processing tool 120, which may include a set of processing tools, a chemical analysis unit 140, and a chemical transport conduit 130, which is capable of transporting chemical compounds. The chemical transport conduit 130 is capable of transporting process chemical compounds from the process chemical unit 110 to the processing tools 120. The process chemical unit 110 may store chemicals, mixtures of various compounds, and/or prepare chemicals for use by various processes performed by the processing tools 120.

The chemical transport conduit 130 may comprise various mechanical and electrical devices designed to generate pressure and/or other stimuli to transport the chemical compound/slurry from the process chemical unit 110 to the processing tools 120. The chemical transport conduit 130 may comprise various sensors that provide data to the chemical analysis unit 140. The chemical analysis unit 140 is capable of analyzing data from various sensors in an online and/or an off-line manner. The chemical analysis unit 140 is also capable of providing feedback signals to affect the chemical characteristics of the slurry in the chemical transport conduit 130.

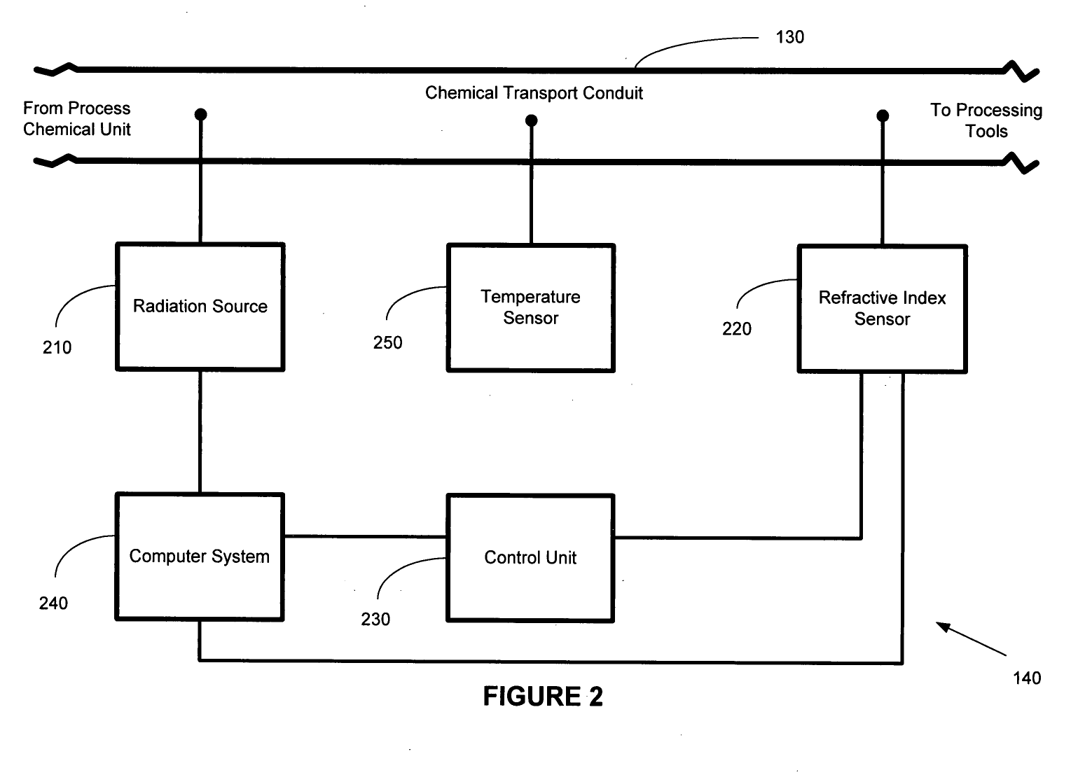

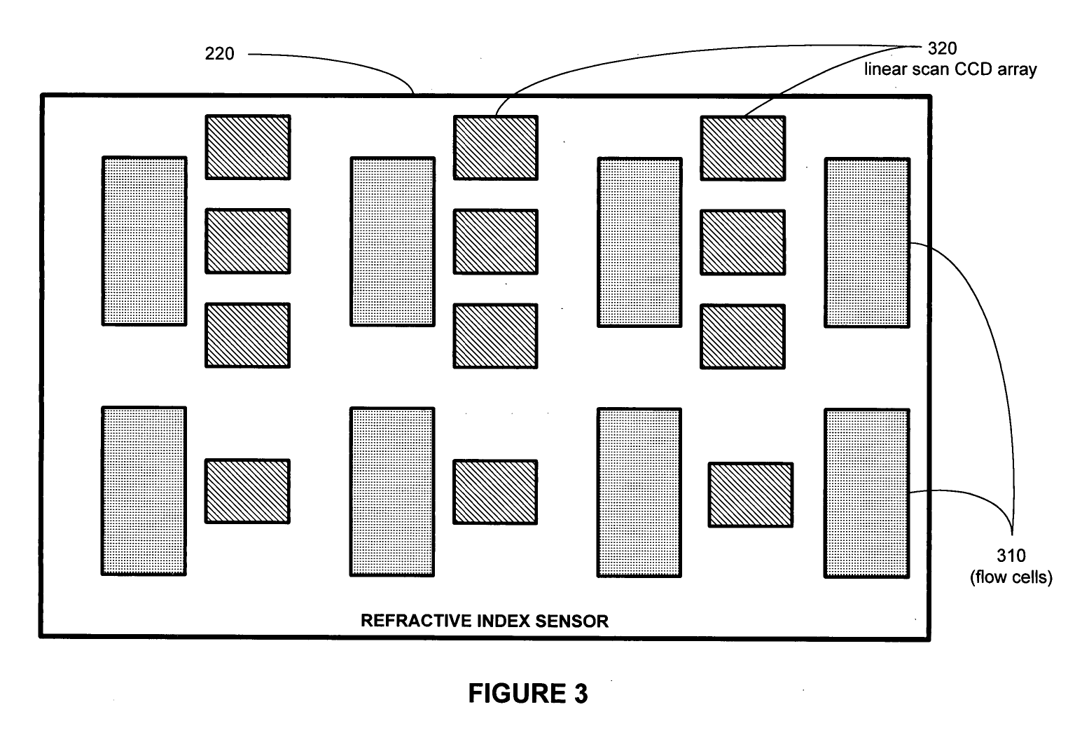

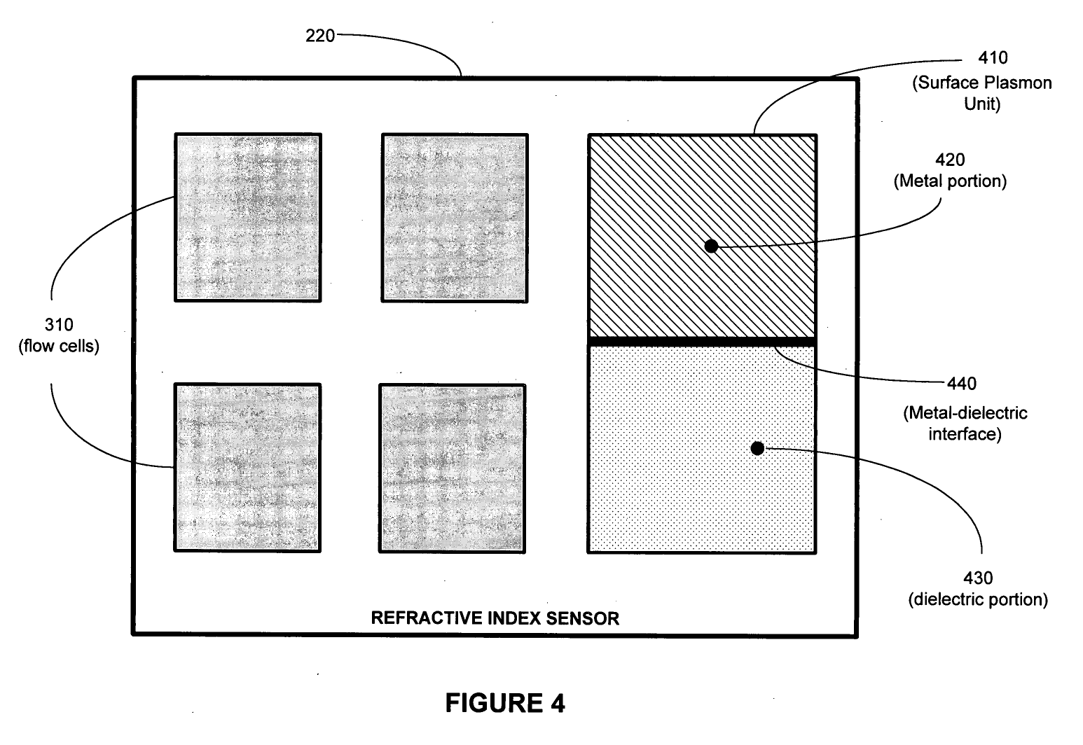

Turning now to FIG. 2, a block diagram depiction of the chemical analysis unit 140, in accordance with embodiments of the present invention is illustrated. In one embodiment, the chemical analysis unit 140 comprises a radiation source 210 that is capable of providing radiation into the chemical transport conduit 130. In one embodiment, the radiation source 210 may be an optical source 210 that is capable of providing an optical radiation of various wavelengths, for example, but not limited to, wavelengths from 800 nanometers to 10,000 nanometers. The chemical analysis unit 140 also comprises a refractive index sensor 220 that is capable of detecting the refractive index detected in the chemical transport conduit 130. A more detailed illustration and description of the refractive index sensor 220 is provided in FIGS. 3 and 4 and accompanying description below.

The refractive index sensor 220 provides data relating to the refraction index to a computer system 240 and to a control unit 230. In one embodiment, the control unit 230 may be integrated into the computer system 240. The control unit 230 is capable of controlling the operation of the radiation source and the refractive index sensor 220. The control unit 230 is also capable of affecting the operation of the chemical transport conduit 130. The computer system 240 is capable of analyzing data from the refractive index sensor 220.

The chemical analysis unit 140 may also comprise a temperature sensor 250 that is capable of sensing the temperature of the process chemical in the chemical transport conduit 130. Data from the temperature sensor 250 may also be analyzed by the computer system 240. This analysis may be used to affect and/or calibrate the refractive index sensor 220. The results from the refractive index sensor 220 may be adjusted or calibrated based upon the temperature detected by the temperature sensor 250. The chemical analysis unit 140 is capable of determining the refraction index of the process chemical into the chemical transport conduit 130 and making a determination as to the chemical state of the process chemical or slurry in the chemical transport conduit 130. Based upon the characterization of the chemical state of the slurry in the chemical transport conduit 130, the computer system 240 may perform various resulting tasks, such as stop the flow of the chemical transport conduit 130, affect the chemical characteristic of the process chemical in the chemical transport conduit 130, and the like.

The chemical analysis unit 140 may be capable of correlating changes in concentration of particular chemicals (e.g., such as hydrogen peroxide concentration) in the process chemical in the chemical transport conduit 130, to a refractive index. The chemical analysis unit 140 may be capable of performing a linear correlation between the refractive index and the percentage of a particular chemical, e.g., hydrogen peroxide, glycol, and the like, in the process chemical or slurry in the chemical transport conduit 130. The reduction and reception of radiation in the chemical transport conduit 130 may be performed on a portion of the chemical transport conduit 130 (e.g., a slip stream) that may be narrower than other portions of the chemical transport conduit 130.

Turning now to FIG. 3, one embodiment of the refractive index sensor 220 in accordance with embodiments of the present invention is illustrated. In one embodiment, the refractive index sensor 220 may comprise a plurality of linear scan charge-coupled-devices (CCDs). In FIG. 3, an array of linear scan CCDs 320 is illustrated. The linear scan CCD array 320 is capable of detecting the refraction of the radiation provided by the radiation source 210 at various wavelengths. The refraction of the light at various wavelengths may be resultant of the radiation traveling through the liquid medium (process chemical), which is detected by the linear scan CCD array 320. In one embodiment the linear scan CCD array 320 may detect the change in the angle of the light through the process chemical medium, which may be detected by the linear scan CCD array 320 to provide a signal relating to the refraction index.

The refractive index sensor 220 may also comprise one or more flow cells 310. The flow cells 310 are provided for facilitating flow of process chemicals (e.g., slurry or liquid) through the refractive index sensor 220. The flow cells 310 may provide a continuous liquid flow of the process chemical through the sensor for more accurate sensing performed by the linear scan CCD array 320. Utilizing the refractive index sensor 220 of FIG. 3, a refraction index signal may be generated. The chemical analysis unit 140 may then adjust the refraction index signal to compensate for various factors, such as the temperature detected by the temperature sensor 250. The temperature may affect the quantification of the refraction index. Therefore, an adjustment to the refraction index signal based upon the temperature may be performed to calibrate the signal.

Turning now to FIG. 4, an alternative embodiment of the refractive index sensor 220 is illustrated. The depiction illustrated in FIG. 4 provides a plurality of flow cells 310 for providing a continuous liquid flow of process chemical through the refractive index sensor 220. Alternatively, a single flow cell 310 may be used to provide the liquid flow of process chemical through the refractive index. The embodiment provided in FIG. 4 employs a surface plasmon resonance phenomenon to detect the refraction index. The refractive index sensor 220 of FIG. 4 comprises a surface plasmon unit 410. The surface plasmon unit 410 comprises a metal portion 420 and a dielectric portion 430. Additionally, the surface plasmon unit 410 comprises a metal-dielectric interface 440.

On the surface plasmon unit 410, a generation of surface plasmons may occur at the metal-dielectric interface 440. The generation of the surface plasmons at the metal-dielectric interface 440 relates to the refractive index of the liquid medium (process chemical) in which the surface plasmon unit 410 is exposed. Therefore, the flow cells 310 provide a continuous flow of the liquid medium in the chemical transport conduit 130, which exposes the liquid medium to the surface plasmon unit 410, which generates surface plasmons at the metal-dielectric interface 440. Hence, the refractive index may then be quantified by using the surface plasmon unit 410 illustrated in FIG. 4. The refractive index data provided by the refractive index sensor 220 of FIG. 4 may also be adjusted based upon the temperature of the liquid medium in the chemical transport conduit 130, which may be detected by the temperature sensor 250.

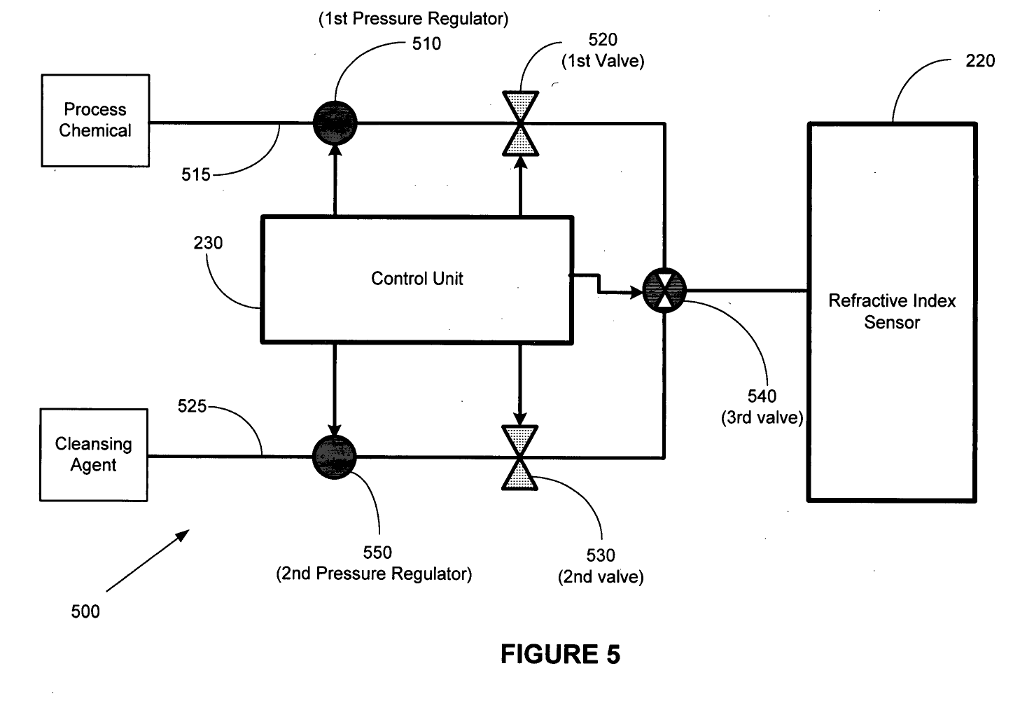

In one embodiment, an apparatus may be provided to direct the process chemical in the chemical transport conduit 130 to the refractive index sensor 220. FIG. 5 illustrates a slip stream 500, which may be placed at various locations on the chemical transport conduit 130, provides for directing a portion of the process chemical in the chemical transport conduit 130 to be sent to the refractive index sensor 220. A line 515 routes process chemicals or slurry from the chemical transport conduit 130 to the slip stream 500. The control unit 230 may control the operation of the slip stream 500.

The line 515 in the slip stream 500 may be opened by a first valve 520. A first pressure regulator 510 is capable of regulating sufficient pressure to direct a flow of process chemicals in the line 515 through the first valve 520. In one embodiment, the first valve 520 is a one-way valve that provides the flow of process chemicals from the chemical transport conduit 130 to the refractive index sensor 220. The operation of the first pressure regulator 510 and the first valve 520 may be controlled by signals provided by the control unit 230. When an analysis of the chemical state is desired, the control unit 230 may be directed to provide the process chemical flow to the refractive index sensor 220 via the line 515. The control unit 230 may also provide a signal to a third valve 540 to direct flow from the line 515 to the refractive index sensor 220. In one embodiment, the third valve 540 may be a two-way valve.

Upon completion of one or more chemical state analyses, repeat performance of the chemical state analysis may cause the refractive index sensor 220 to drift due to one or more causes. One such cause may be that as the liquid medium (process chemical) begins to coat the walls of the refractive index sensor 220, the sensor 220 may drift in one direction or another. This drift in the refractive index sensor 220 may adversely affect the chemical property analysis performed by the system 100. In order to reduce the drifting of the refractive index sensor 220, the slip stream 500 may also comprise a line 525, which provides a cleansing agent (e.g., DI water) to the refractive index sensor 220.

The flow of the cleansing agent may be initiated by a second valve 530, which may facilitate a flow of the cleansing agent in the line 525, into the refractive index sensor 220. The control unit 230 may provide a signal to the second valve 530 and also initiate the operation of a second pressure regulator 550 to provide pressure for the flow of the cleaning agent on the line 525. Additionally, the control unit 230 may control the third valve 540 to cut off flow from the line 515 and open the flow from the line 525 to provide cleaning agent to the refractive index sensor 220. Therefore, flushing the refractive index sensor 220 with the cleansing agent may reduce drift of the sensor 220, thereby providing a sensor calibration function. After performing chemical property analysis, the system 100 calibrates the refractive index sensor 220 by performing a flushing/cleansing of the refractive index sensor 220, thereby reducing possible drifts of the refractive index sensor 220.

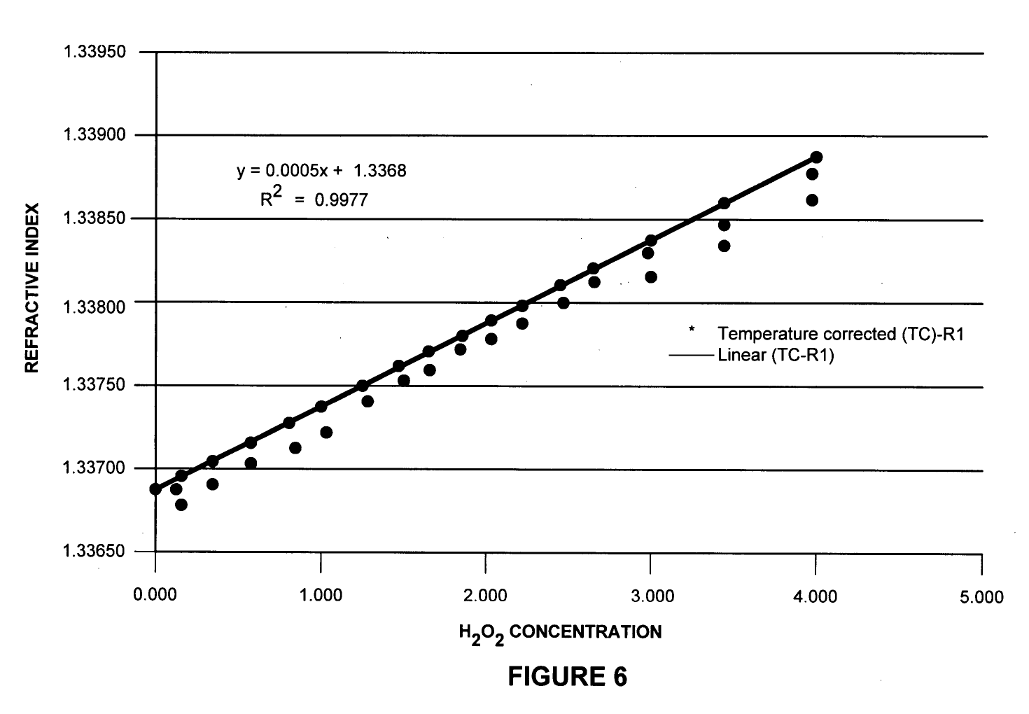

Turning now to FIG. 6, one example of quantifying the concentration of H₂O₂ using a refractive index analysis is illustrated. Various measurements indicate that change in chemical consistency generally has an impact upon the refractive index. For example, as shown in FIG. 6, the correlation between refractive index on the y-axis to hydrogen peroxide concentration on the x-axis is illustrated. FIG. 6 illustrates that if more hydrogen peroxide concentration were to change between 0% and 4%, the refractive index generally follows a linear path. The refractive index changes linearly with the change in hydrogen peroxide concentration. The refractive index data in FIG. 6 has been adjusted for temperature factors (i.e., calibration based upon temperature of the process liquid being analyzed). Therefore, if the hydrogen peroxide level varies in the system 100, analysis of the refractive index may be used to monitor that change.

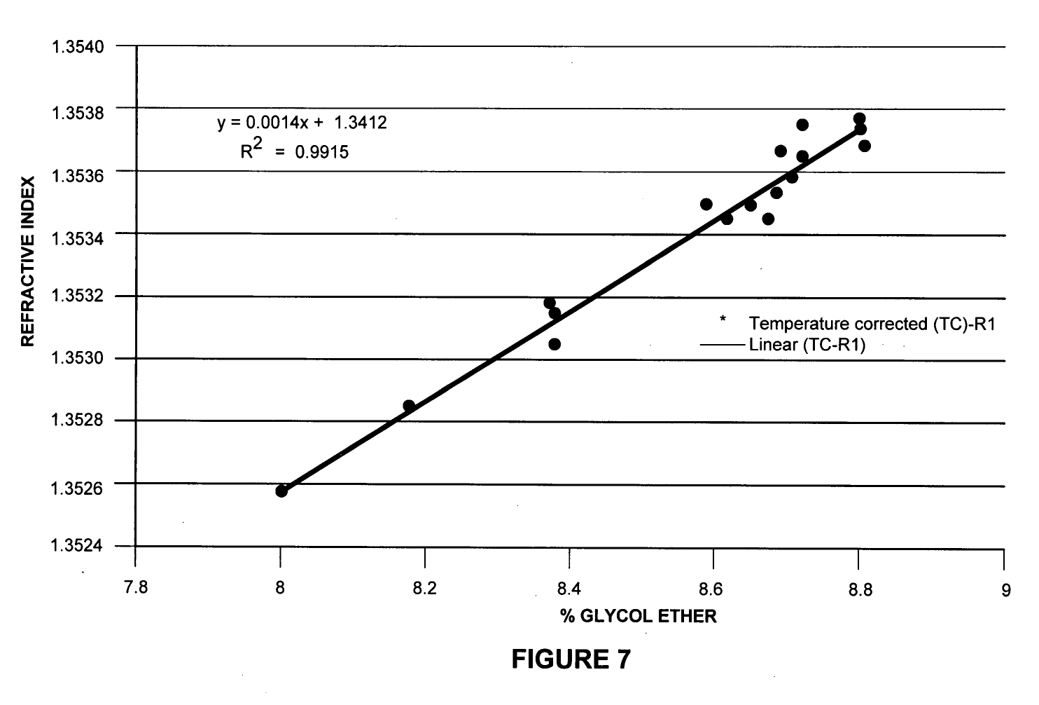

Turning now to FIG. 7, a change in the refractive index as a function of the percentage of glycol ether, which may be a component in a process chemical (slurry), utilized for processing semiconductor wafers is illustrated. In FIG. 7, a percentage of glycol ether also follows a linear correlation between the refractive index. Other chemical concentrations may be developed to provide a relationship with the refractive index. The refractive index data in FIG. 7 has also been adjusted for temperature factors (i.e., calibration based upon the temperature of the process liquid being analyzed).

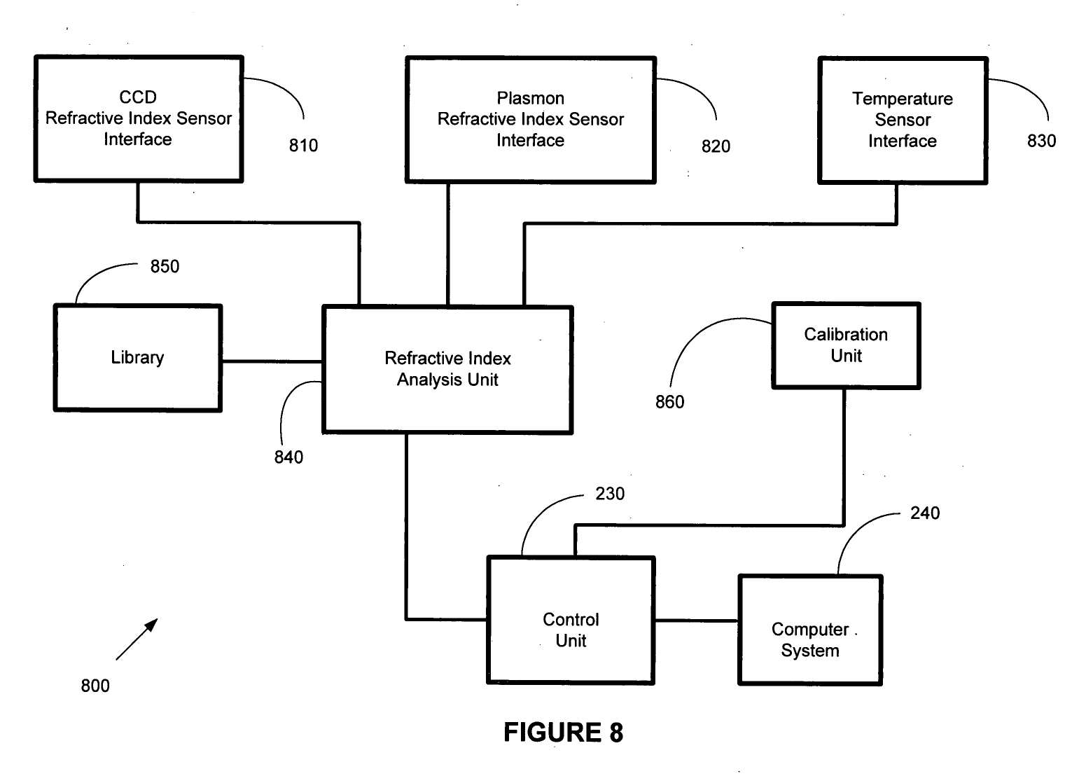

Based upon the relationship between the refractive index and various chemicals in the chemical transport conduit 130, which may be predetermined by experimental measurements and/or theoretical calculations, a set of particular refractive indexes that correlate to particular concentrations of various chemicals may be developed into a list or a library 850. (See FIG. 8). When utilizing the monitoring analysis provided by the system 100 of the present invention, a change in the refractive index may be used to correlate it with one or more events in the process, which may lead one to provide corrections to various processes relating to the delivering of process chemicals to a processing tool 120.

Turning now to FIG. 8, a more detailed block diagram depiction of a system 800 in accordance with embodiments of the present invention is illustrated. In one embodiment, the system 800 comprises a CCD refractive index sensor interface 810 that is capable of receiving a signal from the refractive index sensor 220 and processing the signal. The interface 810 is capable of deciphering the signal from the sensor 220 as a particular refractive index. The system 800 also comprises a plasmon refractive index sensor interface 820 that is capable of receiving a signal from the refractive index sensor 220 and converting the signal to a data signal that may be deciphered to provide a refractive index. The system 800 also comprises a temperature sensor interface 830 that is capable of deciphering the temperature of the chemical transport conduit 130 based upon the signal received from the temperature sensor 250.

A refractive index analysis unit 840 is capable of performing an analysis of the refractive index, which may include adjusting the refractive index number based upon the temperature of the process chemical (e.g., slurry). Additionally, the refractive index analysis unit 840 may compare the received signals to stored experimental and/or theoretical calculations stored in the library 850. The system 800 also comprises a calibration unit 860 that is capable of calibrating the refractive index sensor 220. The calibration unit 860 may detect a drift of the refractive index sensor 220. The calibration unit 860 may also then prompt the control unit 230 to control the first, second, and third valves 520, 530, 540, and the first and second pressure regulators 510, 550, for flushing the refractive index sensor 220 with a cleaning agent. This calibration process may provide for a reduction in the drift by the refractive index sensor 220. The control unit 230 may also detect any leaks of the process chemicals in the chemical transport conduit 130 or in the slip stream 500. Any detected leaks may be reported to the computer system 240, which may report such an event to various operators. The control unit 230 then provides for sampling of chemicals and/or cleaning agents into the refractive index sensor 220 for analysis or calibration.

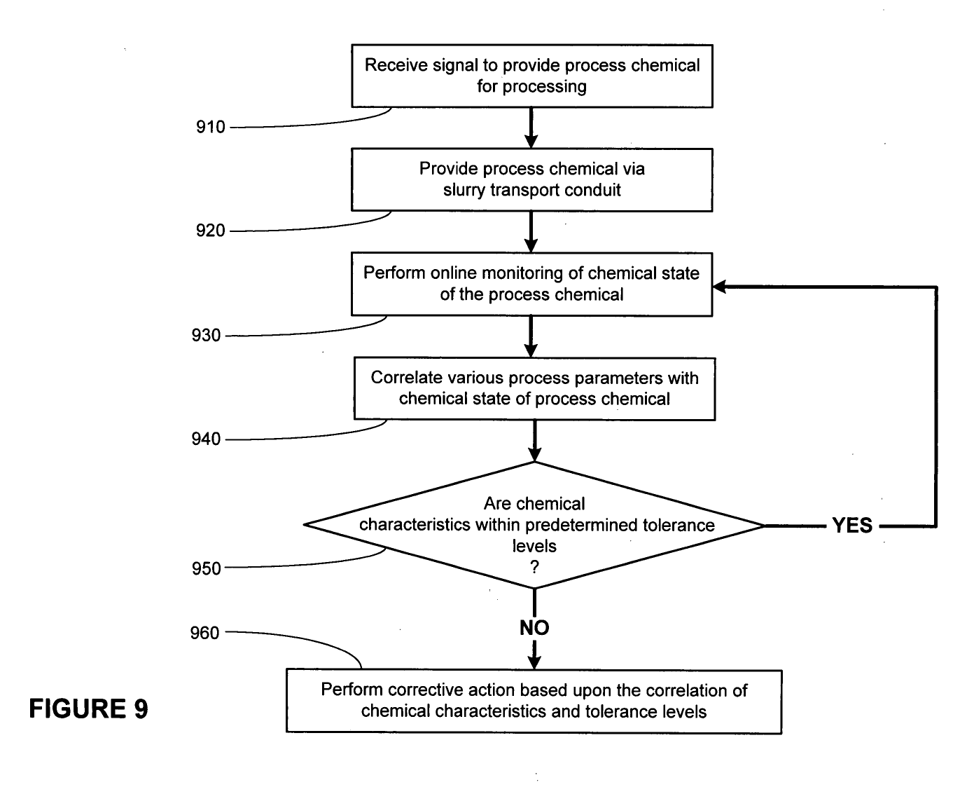

Turning now to FIG. 9, a method in accordance with embodiments of the present invention is illustrated. Generally, the system 100 receives a signal to provide a process chemical (e.g., slurry) for use in processing semiconductor wafers (block 910). Based upon such a request, the system 100 provides the chemical/slurry to the processing tools 120 via the slurry transport unit 130 (block 920). Various pressures and velocities are calculated for optimum delivery of the slurry, while maintaining desired chemical characteristics of the process chemical (e.g., slurry).

The system 100 also performs an online monitoring of the process chemical (block 930). For example, the system 100 may analyze the refractive index detected in the process chemical to determine the chemical state of the process chemical in the chemical transport conduit 130.

Additionally, the system 100 may also analyze other physical characteristics of the slurry, such as the temperature of the process chemical. Based upon the online monitoring of the process chemical, the system 100 generally correlates various process parameters relating to the delivery of the process chemical (block 940). For example, the system 100 correlates the flow rate of the slurry to the percentage degradation of a particular compound (e.g., hydrogen peroxide or glycol ether) in the process chemical in the chemical transport conduit 130.

The system 100 makes a determination whether the chemical state of the process chemical are within predetermined tolerance levels (block 950). For example, the system 100 determines whether the concentration of various compounds in the process chemical have not degraded above a predetermined threshold. These predetermined tolerance levels are generally calculated specifically for the type of process being performed, the characteristics of the type of compounds and abrasives in the process chemical, and the like. The predetermined tolerance levels may be stored in the library 850 for access and comparison by the system 100.

When the system 100 determines that the chemical state of the process chemical is within predetermined tolerance levels, the system 100 generally continues to perform online monitoring of the slurry as indicated in block 930 of FIG. 9. The frequency of the online monitoring of the chemical state of the process chemical may be variable, and may depend on the specific type of slurry/chemicals used for particular processes (e.g., the particular type of CMP being implemented).

If the system 100 determines that the chemical state of the process chemical is not within predetermined tolerance levels, the system 100 performs corrective action based upon the correlation of the chemical state and tolerance levels (block 960). The corrective actions may include various tasks, such as adjusting the flow rate in the slurry transport conduit 130, adjusting the pressure experienced by the slurry, further mixing of the slurry, adding various compounds to the process chemical, terminating wafer processing, and/or the like. The method steps illustrated in FIG. 9 are performed to obtain adequate and acceptable chemical state characteristics of the process chemical when delivering it from the process chemical unit 110 to the processing tools 120. Therefore, the process chemical/slurry used by the processing tools 120 may then be within predetermined tolerance levels, thereby providing for a more uniform quality of processed semiconductor wafers.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. An apparatus, comprising:
a radiation source for providing a radiation signal into a process chemical;
a refraction index sensor for detecting a refraction index resulting from said radiation signal; and
a controller to determine whether a chemical state of said process chemical is within a predetermined tolerance level in an online manner, in response to said refraction index.

2. The apparatus of claim 1, wherein said process chemical is in the form of a slurry.

3. The apparatus of claim 1, wherein said radiation signal is capable of being modified as a function of a chemical state of said process chemical.

4. The apparatus of claim 3, wherein said radiation signal has a wavelength in the range of approximately 800 nanometers to approximately 10,000 nanometers.

5. The apparatus of claim 3, wherein said controller is capable of determining a concentration of a chemical in said process chemical based upon said refraction index.

6. The apparatus of claim 1, wherein said controller is adapted to compare said refractive index to a predetermined tolerance level stored in a library to determine whether said chemical state of said process chemical is within a predetermined tolerance level.

7. The apparatus of claim 1, further comprising a temperature sensor, said temperature sensor to determine a temperature of said process chemical.

8. The apparatus of claim 7, wherein said controller is adapted to correlate a chemical state of said process chemical with at least one of said temperature of said process chemical and a flow rate of said process chemical.

9. The apparatus of claim 1, further comprising a chemical transport conduit for transporting said process chemical to a processing tool.

10. The apparatus of claim 9, further comprising a slip stream for sampling said process chemical, said slip stream being coupled with a portion of said chemical transport conduit.

11. The apparatus of claim 10, wherein said slip stream comprises a first pressure regulator to regulate a pressure to provide said process chemical flow into said slip stream.

12. The apparatus of claim 11, wherein said slip stream comprises a first valve regulator to control the flow of said process chemical into said slip stream.

13. The apparatus of claim 10, wherein said slip stream comprises a second pressure regulator to regulate a pressure to provide a flow of cleansing agent into said slip stream.

14. The apparatus of claim 13, wherein said slip stream comprises a first valve regulator to control the flow of said cleansing agent into said slip stream.

15. The apparatus of claim 10, wherein said slip stream comprises a third valve for directing a flow of at least one of said process chemical and said cleansing agent into said refractive index sensor.

16. The apparatus of claim 1, wherein said refraction index sensor comprises a flow cell for directing a flow of said process chemical into said refraction index sensor.

17. The apparatus of claim 1, wherein said refraction index sensor comprises a charge coupled device (CCD) for detecting said refraction index.

18. The apparatus of claim 1, wherein said refraction index sensor comprises a plasmon surface unit detecting said refraction index, said plasmon surface unit comprising a metal portion, a dielectric portion, and a metal-dielectric interface for detecting a surface plasmon.

19. A system, comprising:
a process chemical unit to provide a process chemical for processing a semiconductor wafer;
a processing tool to perform a process upon a semiconductor wafer using said process chemical;
a process chemical transport conduit to transport said process chemical from said process chemical unit to said processing tool; and
a chemical analysis unit to perform an online analysis of said process chemical in said process chemical transport conduit, said chemical analysis unit comprising a refraction index sensor for detecting a refraction index resulting from a radiation signal and a controller to determine whether a chemical state of said process chemical is within a predetermined tolerance level in an online manner, in response to said refraction index.

20. The system of claim 19, wherein said processing tool is adapted to perform a chemical-mechanical planarization process upon said semiconductor wafer.

21. The system of claim 19, wherein said process chemical is in the form of a slurry.

22. The system of claim 19, wherein said radiation signal has a wavelength in the range of approximately 800 nanometers to approximately 10,000 nanometers.

23. The system of claim 22, wherein said controller is capable of determining a concentration of a chemical in said process chemical based upon said refraction index.

24. The system of claim 19, wherein said controller is adapted to compare said refractive index to a predetermined tolerance level stored in a library to determine whether said chemical state of said process chemical is within a predetermined tolerance level.

25. The system of claim 19, further comprising a temperature sensor, said temperature sensor to determine a temperature of said process chemical.

26. The system of claim 25, wherein said controller is adapted to correlate a chemical state of said process chemical with at least one of said temperature of said process chemical and a flow rate of said process chemical.

27. The system of claim 19, further comprising a slip stream for sampling said process chemical, said slip stream being coupled with a portion of said chemical transport conduit.

28. The system of claim 27, wherein said slip stream comprises a first pressure regulator to regulate a pressure to provide said process chemical flow into said slip stream.

29. The system of claim 28, wherein said slip stream comprises a first valve regulator to control the flow of said process chemical into said slip stream.

30. The system of claim 27, wherein said slip stream comprises a second pressure regulator to regulate a pressure to provide a flow of cleansing agent into said slip stream.

31. The system of claim 30, wherein said slip stream comprises a first valve regulator to control the flow of said cleansing agent flow into said slip stream.

32. The apparatus of claim 27, wherein said slip stream comprises a third valve for directing a flow of at least one of said process chemical and said cleansing agent into said refractive index sensor.

33. The system of claim 19, wherein said refraction index sensor comprises a flow cell for directing a flow of said process chemical into said refraction index sensor.

34. The system of claim 19, wherein said refraction index sensor comprises a charge coupled device (CCD) for detecting said refraction index.

35. The system of claim 19, wherein said refraction index sensor comprises a plasmon surface unit detecting said refraction index, said plasmon surface unit comprising a metal portion, a dielectric portion, and a metal-dielectric interface for detecting a surface plasmon.

36. A method, comprising:
receiving a request to provide a process chemical to a processing tool;
transporting said process chemical through a chemical transport unit to said processing tool based upon said request; and
performing an online monitoring of a chemical state of said process chemical, said online monitoring comprising analyzing a refractive index signal caused by the presence of a radiation signal sent through said process chemical to determine whether said chemical state of said process chemical is within a predetermined level of tolerance.

37. The method of claim 36, wherein performing said online monitoring of said chemical state of said process chemical further comprises determining a concentration of a chemical in said process chemical based upon said refractive index signal.

38. The method of claim 37, wherein determining a concentration of a chemical in said process chemical based upon said refractive index signal further comprises determining a concentration of hydrogen peroxide in said process chemical based upon said refractive index signal.

39. The method of claim 37, wherein determining a concentration of a chemical in said process chemical based upon said refractive index signal further comprises determining a concentration of glycol ether in said process chemical based upon said refractive index signal.

40. The method of claim 36, wherein performing an online monitoring of said chemical state of said process chemical further comprises determining a temperature of said process chemical.

41. A computer readable program storage device encoded with instructions that, when executed by a computer, performs a method, comprising:
receiving a request to provide a process chemical to a processing tool;
transporting said process chemical through a chemical transport unit to said processing tool based upon said request; and
performing an online monitoring of a chemical state of said process chemical, said online monitoring comprising analyzing a refractive index signal caused by the presence of a radiation signal sent through said process chemical to determine whether said chemical state of said process chemical is within a predetermined level of tolerance.

42. The computer readable program storage device encoded with instructions that, when executed by a computer, performs the method of claim 41, wherein performing said online monitoring of said chemical state of said process chemical further comprises determining a concentration of a chemical in said process chemical based upon said refractive index signal.

43. The computer readable program storage device encoded with instructions that, when executed by a computer, performs the method of claim 41, wherein performing an online monitoring of said chemical state of said process chemical further comprises determining a temperature of said process chemical.

44. The computer readable program storage device encoded with instructions that, when executed by a computer, performs the method of claim 43, wherein performing an online monitoring of said chemical state of said process chemical further comprises calibrating said refractive index signal based upon said temperature of said process chemical.
